(19) United States
(12) Patent Application Publication
(10) Pub. No.: US 2020/0234014 A1
(43) Pub. Date: Jul. 23, 2020

(54) IDENTITY CARD HOLDER AND SYSTEM

(71) Applicant: SoloProtect Limited, Sheffield (GB)

(72) Inventor: Craig Swallow, Sheffield (GB)

(21) Appl. No.: 16/788,241

(22) Filed: Feb. 11, 2020

Related U.S. Application Data
(63) Continuation of application No. 14/822,673, filed on Aug. 10, 2015, now abandoned.

(30) Foreign Application Priority Data
Aug. 14, 2014 (GB) 1414410.9

(51) Int. Cl. G06K 7/10; H04L 9/32

(52) U.S. Cl. CPC G06K 7/10366; H04L 9/3247

(57) ABSTRACT

An identity card holder with a processor, a memory, an antenna, an interface for communicating with an identity card, positioning circuitry for obtaining position data of the identity card holder and communications circuitry for communicating with a remote server apparatus. The processor being configured to receive identification data from the identity card via the interface to identify a user, to cause a credential of the user associate with the identity card to be determined, to obtain position data of the identity card holder from the positioning circuitry and to cause restricted information related to a location to be provided to the user, where the restricted information has an access requirement related to the credential of the user and wherein the restricted information is provided to the user only if the user credential meets the access requirement and the position of the identity card holder is proximate the location.

### CROSS REFERENCE TO RELATED APPLICATION

This application is a continuation of U.S. patent application Ser. No. 14/822,673 filed on Aug. 10, 2015, which claims priority to Great Britain Patent Application No. GB1414410.9 filed on Aug. 14, 2014, the contents of which are incorporated by reference herein.

### FIELD OF INVENTION

The invention is in the field of devices that provide access to restricted information and in particular, in the field of identity card holders that operate within a security system.

### BACKGROUND

A company may hold and deal with a large amount of information, some of which may be required by employees of the company, or associated contracting personnel, to complete tasks. The information held by a company can be highly sensitive and therefore access to said information is often restricted. Certain tasks for completion may relate to restricted information. Only individuals that are authorised to be able to carry out the work needed to complete a task, and authorised to access the restricted information relating to the task, should be able to complete the task.

For a company to be successful, security of the information held by a company is paramount and it is essential for a company to uphold a high level of integrity, i.e. a company would not want their reputation negatively affected by restricted company information being mistakenly released or leaked into the public domain, or by tasks being carried out to a sub-standard level by a person who is not authorised to compete such tasks. It is vital for companies to work smoothly, minimise mistakes that are made, securely hold sensitive information by implementing a robust security of information system, wherein the security of information system has a means for authorising access to the restricted information, and to ensure that the employees of the company are safe and protected. The company may also wish to provide an accurate audit trail of accesses made to the restricted information, the location at which an access was made and the time when the access was made. Unsuccessful attempts to access the restricted information of the company may also be recorded. The company may also wish to provide an audit trail in which the completion of tasks and the use of equipment is logged.

To minimise the opportunity for a person who is not authorised to access restricted information from being able to access the restricted information, and then perhaps completing a related task, it is useful to have a security system which verifies the identity of a user.

In conventional systems, where employees or workers may carry identity cards, it is possible for one employee to obtain a second employee's identity card and for example, gain access to restricted information to which the second employee (and not necessarily the first employee) is normally cleared to access. The first employee may then complete a task relating to the restricted information that the second employee, and not the first, is authorised to access which could potentially result in a task being completed to a level that is below satisfactory which could harm others, the employee or the reputation of the company. Alternatively, the first employee could choose to leak the restricted information to other employees, third parties, or to the public which, again, may result in harm to others, the employee or the reputation of the company.

In conventional systems, such as the one described above, the completion of tasks may not be recorded, for example in a paper or computing file system, and so therefore not logged in an audit trail, until the end of a worker's shift which may be perhaps hours after the task has been completed. This means the audit trail of a company is not correct when it is viewed in real time. Further to this, since it is not known immediately when a task has been completed, secondary tasks to be completed at the same location may then be delayed from starting until the completion of the first task is logged on the system, which means the company as a whole is not working at full efficiency. Having an audit trail that is only updated at the end of a worker's shift could lead to inaccurate audit trails as workers may alter the time of completion, or the equipment used to complete the task if they for example, wanted to be perceived by others as being a quick worker or if they used equipment that was not necessarily the correct equipment that should have been used to complete the task.

Several independent aims of the invention are set out below, and the applicant desires to satisfy one or more of these aims with the invention disclosed.
1. It is an aim of the invention to provide an information security system that provides restricted information to workers pertaining to certain tasks, yet ensures that the restricted information pertaining to a certain task is only accessed by workers that are authorised to access the restricted information, thereby improving security of information and reducing the chance of non-qualified persons from carrying out tasks related to the restricted information.
2. It is another aim of the invention to provide an information security system that is implemented quickly and efficiently.
3. It is an aim of the invention to implement a robust information security system that is easy to use and will not slow down a worker's progress on a particular task.
4. It is another aim of the invention to provide a security system that creates an audit trail that is more accurate, immediate and dependable.
5. Companies may also come under cyber-attack regularly, and hackers may remotely target internal computer systems of a company that hold a vast quantity of data, some of which is sensitive and confidential. It is therefore an aim of the invention to provide a more robust security system not only against workers but also from external and remote threats.

### SUMMARY OF INVENTION

According to the invention there is provided an identity card holder comprising a processor, a memory, an antenna, an interface for communicating with an identity card, positioning circuitry for obtaining position data of the identity card holder and a communications circuitry for communicating with a remote server apparatus. The processor is configured to receive identification data from an identity card via the interface to identify a user, to cause a credential of the user associated with the identity card to be determined, to obtain position data of the identity card holder from the positioning circuitry, and to cause restricted information related to a location to be provided to the user wherein the restricted information has an access requirement related to the credential of the user. The restricted information is provided to the user only if the user credential meets the access requirement and the position of the identity card holder is proximate the location.

In this way, firstly, to gain access to the restricted information two separate criteria must be met, making it harder to gain access to restricted information and thus, the restricted information is more securely protected. For example, even if the credential of the user meets the access requirement of the restricted information the user will not be provided with the restricted information if the position of the identity card holder is not proximate the location. Secondly, the restricted information is limited to only being accessible when the position of the identity card holder is proximate the location, and this means that remote access of the restricted information cannot be achieved thus, the restricted information is more securely protected. Thirdly, an audit trail can be easily and accurately kept up to date because the identification data (associated with the user and read from the identity card), and the position data of the identity card holder, can be logged in an audit trail to track the location of the user of the identity card holder. The exact time, date and location in which the restricted information was provided to the user may also be logged creating a comprehensive, immediate and accurate audit trail.

Preferably, the restricted information related to a location is inaccessible to the user when the position of the identity card holder is no longer proximate the location. This means the restricted information cannot be viewed anywhere other than within a specified range of the location making the restricted information more secure because the restricted information cannot be provided to the user, on for example a display device such as a smartphone or tablet or a laptop computer, when the position of the identity card holder is moved from the location to which the restricted information is associated. The restricted information cannot then be read, used, copied or shared with others who are not authorised to view the restricted information. This also provides additional audit confidence as any information inputs relating to the restricted information is less likely to be faked.

According to two preferred iterations of the invention, the identity card is proximate the location if the position of the identity card holder is one or more of the following: globally verified to be within a specified range of the location, or locally verified to be within a specified range of the location, or locally verified to be at the location. The identity card holder of the invention can optionally obtain global position data of the identity card holder via GPS and GSM localisation or the like, or obtain local position data of the identity card holder through communications with the location via Bluetooth®, RFID, or the like. Additionally or alternatively, local position data of the identity card holder can be obtained upon entry of a location ID of the location into the identity card holder. The identity card holder may be configured to scan the location ID or to receive the location ID through manual input.

According to the invention, the local position data of the identity card holder, obtained upon entry of the location ID of the location, can verify one or more of the following to be logged on the audit trail: a task to be completed at the location and the equipment that will be used at the location. An advantage of this is that with only the knowledge of the location ID, an comprehensive audit trail can be created that includes details of the task to be completed and the equipment that will be used by the user at the location, this allows minimum input from the user and thus less chance for errors and creates an accurate account for what is expected to take place at the location associated with the inputted location ID.

According to the invention, the identity card holder may be configured to verify and log in the audit trail the equipment to be used at the location upon entry of an equipment ID into the identity card holder.

According to the invention the identity card holder may be configured to cause the restricted information to be inaccessible to the user when a time limit relating to the restricted information has completed. This has an advantage of ensuring the restricted information is being used effectively in the time limit because the user will be conscious of not having endless access to the restricted information even if the user remains proximate the location. Additional audit confidence is provided as any information inputs relating to the restricted information is less likely to be faked because the restricted information is only accessible for a limited period of time.

According to the invention, the identity card holder may be configured to cause the restricted information to be inaccessible to the user unless the location ID is re-entered into the identity card holder within a specified time limit associated with the location relating to the restricted information. This has the advantage of ensuring the user remains proximate the location throughout the period in which they are viewing the restricted information and so the restricted information cannot be provided to the user when the position of the identity card holder is proximate the location and then taken away from the location to which it is associated and read, used, copied or perhaps shared with others who are not authorised to view the restricted information relating to the location.

The positioning circuitry of the identity card holder may monitor the position of the identity card holder repeatedly. The identity card holder may be configured to receive the restricted information related to the location automatically from the remote server apparatus when the identity card holder is proximate the location and the user credential meets the access requirement of the restricted information. An advantage of pushing the restricted information automatically to the user is that the user does not have to interact with a display device or the identity card holder making the process of receiving restricted information easier and less complex for the user. The overall process of completing the task is also quicker and more efficient.

According to the invention, the identity card holder is preferably configured to provide the user with a dialogue prior to providing the restricted information related to the location to the user, wherein the dialogue questions the user if they want to receive the restricted information related to the location and wherein the identity card holder is configured to receive a response from the user. The dialogue presented to the user may include options if the position of the identity card holder coincides with more than one location relating to restricted information. An advantage of questioning the user whether the user wants to receive restricted information is that the user will not be sent information they do not want to view, for example they may pass through a specified range of a first location on route to a second location and may not be ready to receive the restricted information relating to the first location, this reduces the opportunity for mistakes in audit trail to occur and minimises inconsistencies between the audit trail and real life events, for example the restricted information may be logged as “viewed” in the audit trail when it is automatically sent to a user, whereas in reality, the user did not want to view the restricted information associated with the first location and so did not open the file and did not read the restricted information and thus has not actually “viewed” the restricted information associated with the first location even though it has been logged the contrary. Further to this, the “viewing” of the restricted data may cause a predicted date of completion for the task relating to the restricted information to be calculated, which again would be incorrect as the information has not actually been “viewed” by the user.

Preferably, the identity card holder may be configured to provide the user with a dialogue prior to providing the restricted information related to the location to the user, wherein the dialogue requests the user to input identification data. An advantage of this stage of verification is that the security of the system is improved and ensures people authorised to access the restricted information are gaining access to the restricted information whilst minimising the opportunity for a person who is not authorised to gain access to the restricted information from gaining access to the restricted information. The safety of users, for example on a maintenance site, is also improved as the risk that someone that is unauthorised, for example unqualified, will be working, checking, calibrating or maintaining machinery on which they are not trained because the identification data of the unauthorised user would not correspond to identification data of users whose credentials meet the access requirement of the restricted information and are thus authorised to access the restricted information. The making of an audit trail is easier and more accurate as exact time, dates, equipment and workers can be recorded instantaneously once the work has been completed at a certain location or optionally, once the work has commenced at a certain location.

In one implementation, the identity card holder may have mobile communication ability and be configured to receive an incoming call from an authorised contact to verify the identification of the user through voice-check or requesting a password. In this way, the security of the system is increased because using an authorised contact to verify the identification of the user is a trustworthy and dependable procedure that is harder to fool and manoeuvre around.

Preferably, the identity card holder may be configured to send an access request issued by the user to the remote server apparatus, wherein the restricted information is only provided to the user once the access request has been classified as a valid request. Preferably, the access request is classified as a valid request if the position data of the identity card holder and the access request are received by the remote server apparatus either at the same time, or within a specified time difference of one another. An advantage of the requirement of an access request gives the user more control about what restricted information they wish to receive. A further advantage of an access request is that in some instances the positioning circuitry does not need to monitor the position of the identity card holder repeatedly, the positioning circuitry only needs to obtain position data once an access request has been issued by the user, which will help save energy in the power source of the identity card holder.

According to the invention, the identity card holder may have an interface, such as a display, configured to receive input from the user, wherein the input from the user may be one or both of the following: identification data and a response to a dialogue. An advantage of having a display on the identity card holder is that this can eliminate the need for a secondary display device which may speed up the verification process.

Preferably, once the user has finished using the restricted information relating to the location they are presented with a dialogue on the display device which allows the user to sign electronically a dated declaration. An advantage of signing a declaration in real time and sending the signed declaration to the remote server apparatus straight away (i.e., when the “send” option has been chosen by the user, the signed declaration is sent to the remote server apparatus 300) is that an audit trail can be formed easily and quickly with no intermediate administrative stages slowing the process down and making it inefficient.

In one implementation, the identity card holder 100 may be configured to alert the user to a need in an area associated with the location. The alert is preferably an audio instruction, although a vibration or a flashing light may also be used to alert the user. In this way the safety of the user is increased and in particular, the alert reaches the user in a quick and reliable way. Further to this, having the alert as an audio instruction means details of an evacuation or potential threat can be communicated to the user that are accurate and informative, for example a location of a fire may be communicated to the user or the user may receive advice relating to the potential threat.

Preferably, the interface of the identity card holder is configured to communicate with the identity card and receive identification data via one of the following: a chip, a magnetic stripe, a barcode, an RFID tag and a NFC tag. The identity card may be a smartcard.

According to the invention, the identity card holder may be configured to hold the identity card so that the identity card is visibly displayed. An advantage of this is that another level of security is added in that users will not be able to use freely an identity card which isn't theirs because the details on the front of the card would not match the user physical appearance of the user wearing the card.

Preferably, the credential of the user to be determined is one of the following: training level, qualification level and security level of the user. The access requirement of the restricted information may be one of the following: a minimum training level, a minimum qualification level and a minimum security level of the user. The identification data is preferably one or more of the following: name, ID number, passcode and biometric data such as fingerprint, iris and voice data of the user.

According to the invention, the restricted information related to a location may be information about a particular task to be carried out wherein the task relates to the location.

According to the invention, the restricted information related to a location may include an inspection sheet, wherein the inspection sheet is a real-time verified documentation that presents the user which a checklist of sub-tasks to be completed at the location; and wherein the inspection sheet is sent to the remote server apparatus to form part of the audit trail after a dated declaration has been electronically signed by the user. The inspection sheet may include one or more of the following: a checklist of sub-tasks related to the location and a checklist of sub-tasks to be performed on equipment located at the location. An advantage of this is that the exact time at which a task is completed can be logged and can then form part of the audit trail giving a comprehensive account of the proceedings that occurred at the location. The inspection sheet helps improve the audit trail as the time of completion of subtasks is logged and not just the time of completion of the overall task. The time of completion of subtasks may also help predict a more accurate completion time for the overall task at the location. The checklist of sub-tasks also minimises the chance of errors in the completion of the overall task because each sub-task is accounted for and the user does not have to remember incremental tasks essential for the completion of the overall task because they are provided to the user on the checklist. The checklist may also include for the reporting of calibration results.

According to the invention, the task to be completed at the location may be one or more of the following: a health worker (e.g. a doctor) performing a health assessment on a patient, a health worker diagnosing a patient, a health worker (e.g. a doctor) prescribing medication to a patient, a health worker using medical equipment on the patient, a maintenance worker (e.g. a technician) calibrating equipment, a maintenance worker repairing maintenance equipment, a maintenance worker checking equipment, a maintenance worker using equipment to repair damage at the location or build a new structure at the location.

According to the invention, the location ID may be located on, for example, one or more of the following: a marker positioned beside a section of railway track, an underground pipe, a post in a construction site, medical equipment of a patient, and a bed of a patient.

According to the invention, the equipment ID may be located on one or more of the following: medical instrumentation devices, diagnostic devices, prescribed drugs and medical treatment devices, for example an inhaler, IV drip, heart monitor or blood pressure monitor. In a further embodiment, the equipment ID may be positioned on one or more of the following: calibration equipment, repair equipment and construction equipment, for example a voltmeter, drill, pipe, section of railway track and a forklift.

According to the invention there is provided a security system comprising an identity card holder, an identity card, a remote server apparatus and a display device of the user. The identity card holder is arranged to: hold the identity card so that the identity card is visibly displayed, receive identification data from the identity card and send the identification data to the remote server apparatus. Positioning circuitry of the identity card holder is configured to obtain position data of the identity card holder and communications circuitry of the identity card holder may be configured to send the position data to the remote server apparatus. The remote server apparatus is configured to determine a credential of the user associated with the identity card and provide the user with restricted information related to a location if the user credential meets the access requirement of the restricted information and the position of the identity card holder is proximate the location. The display device of the user is arranged to receive the restricted information related to a location from the remote server apparatus and display the restricted information related to the location.

According to the invention there is provided a method of obtaining restricted information, the method comprising, in a processor of an identity card holder: receiving identification data from an identity card via an interface to identify a user. The method also comprising causing a credential of the user associated with the identity card to be determined. The method also comprising obtaining position data of the identity card holder from the positioning circuitry. The method also comprising causing restricted information related to a location to be provided to the user. Wherein the restricted information has an access requirement related to the credential of the user. Also, wherein the restricted information is provided to the user only if the user credential meets the access requirement and the position of the identity card holder is proximate the location

According to the invention there is provided a method for accessing restricted information. The method comprises inserting an identity card into an identity card holder so that the identity card held by the identity card holder. The method comprises receiving identification data from the identity card. The method comprises obtaining position data of the identity card holder. The method comprises sending the identification data to a remote server apparatus. The method comprises sending the position data to a remote server apparatus. The method comprises determining a credential of the user associated with the identity card. The method comprises providing restricted information related to a location to a display device of the user, only if the user credential meets an access requirement of the restricted information and the position of the identity card holder is proximate the location.

### BRIEF DESCRIPTION OF THE FIGURES

FIG. 1 is a perspective view of the identity card holder and the identity card.

FIG. 2 is a schematic view of the internal components of the identity card holder.

FIG. 3 is a schematic flow chart that represents the flow of data within the identity card holder.

FIG. 4 is a schematic view of the system in which the identity card holder operates.

FIG. 5 illustrates one embodiment of the invention.

FIGS. 6a and 6b illustrate a further embodiment of the invention.

FIG. 7 illustrates dialogue presented to the user in one embodiment of the invention.

FIG. 8 illustrates a further embodiment of the invention.

FIG. 9 illustrates dialogue presented to the user in one embodiment of the invention.

FIGS. 10a and 10b illustrate further embodiments of the invention.

FIG. 11 illustrates dialogue presented to the user in one embodiment of the invention.

FIG. 12 illustrates dialogue presented to the user in one embodiment of the invention.

FIG. 13 is a flow chart that represents the method of accessing restricted information.

### DETAILED DESCRIPTION

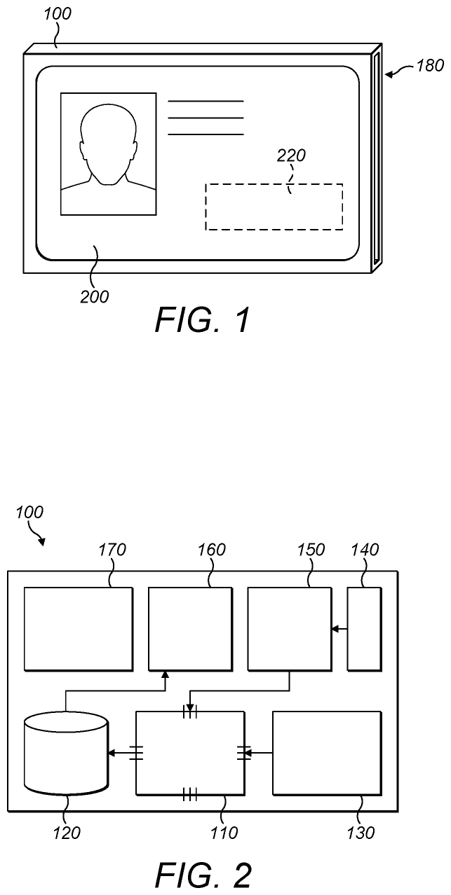

FIG. 1 shows a perspective view of an identity card holder 100 holding an identity card 200 so that the identity card 200 is visibly displayed. The identity card holder 100 may have a display 180 positioned on the reverse of the identity card holder 100 opposite the identity card 200. The display 180 may also be positioned adjacent to the identity card 200. The identity card holder 100 may be attached to the user by a clip, pin or equivalent attachment not shown.

FIG. 2 shows a schematic view of an example of the internal components of the identity card holder 100. The identity card holder 100 comprises a processor 110, a memory 120, an interface 130 for communicating with the identity card 200, an antenna 140, positioning circuitry 150 for obtaining a position data of the identity card holder 100, communication circuitry 160 for communicating with a remote server apparatus 300 and a power source 170. The identity card holder 100 may also have means for receiving identification data inputted by a user, such as a camera, a microphone or the display 180 which may be a touch screen liquid crystal display that, for example, can receive input from the touch of a finger or a pen. The identity card holder 100 may also have a means for sending an access request to a remote server apparatus 300, such as a button or the touchscreen display 180.

The processor 110 of the identity card holder 100 is configured to receive identification data from the identity card 200, to identify a user from the identification data, to cause a credential of the user associated with the identity card 200 to be determined, to obtain position data of the identity card holder 100 from the positioning circuitry 150, and to cause restricted information related to a location to be provided to the user, wherein the restricted information has an access requirement related to the credential of the user, and wherein the restricted information is provided to the user only if the user credential meets the access requirement and the position of the identity card holder 100 is proximate the location. The identity card 200 is configured to be held by the identity card holder 100 and to interact with the interface 130 of the identity card holder 100. The interface 130 is configured to read the identification data from the identity card 200. The positioning circuitry 150 is configured to obtain position data of the identity card holder 100.

The identification data stored on the identity card 200 is one or more of the following: name, ID number and biometric data such as fingerprint, iris and voice data of the user.

The interface 130 has the capability to read either contact or contactless smart cards or both types of smart card. If the identity card 200 is a contact smart card the identity card 200 may be read by the interface 130 using direct electrical coupling to a chip on the identity card 200. If the identity card 200 is a contactless smart card the identity card 200 may have an RFID tag (either active, semi-active, or passive), an NFC tag, a magnetic stripe or a bar code. The positioning circuitry 150 may obtain position data of the identity card holder 100 by GPS, GSM localisation, triangulation, wireless local area network (WLAN), Bluetooth® or by entering a location ID at the location in question. The communication circuitry 160 may typically include a transmitter, a receiver, a low noise amplifier, a frequency synthesiser and an antenna, such as antenna 140.

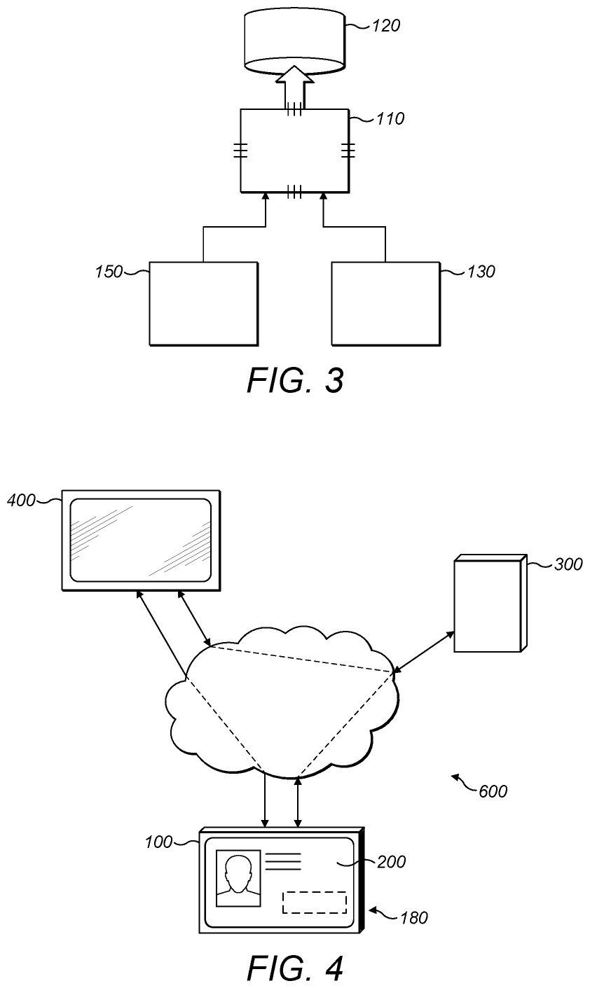

Referring now to FIG. 3 which shows an example of the flow of data within the identity card holder 100. As shown, the interface 130 that communicates with identity card 200 and the positioning circuitry 150 both send data to the processor 110, the data is then processed and sent forward to the memory 120 where it is temporarily stored until it is sent to the remote server apparatus 300 via wireless communications, such as Wi-Fi®, Bluetooth® or radio-frequency.

FIG. 4 shows a schematic view of an example of a system in which the identity card holder 100 operates. A security system 600 is shown that comprises the identity card holder 100 holding the identity card 200, the remote server apparatus 300 and a display device 400 all of which may communicate wirelessly between each other. Wherein the identity card holder 100 is arranged to receive identification data from the identity card 200 and send the identification data to the remote server apparatus 300. The positioning circuitry 150 of the identity card holder 100 is configured to obtain position data of the identity card holder and send the position data to the remote server apparatus 300.

The remote server apparatus 300 stores user data such as name, ID number, credential (one or more of qualification level, training level and security level), biometric data and any other data which may be useful in identifying the user. Depending on the preference of the company, the data stored by the remote server apparatus 300 can be bespoke, such that the company can choose the types of data it wishes to be stored. The minimum data that must be stored on the server 300 is the credential of the user and one other identifying piece of data that is stored on the identity card 200. This is so that a credential can be determined from the identification data obtained from the identity card 200. The server 300 also stores a list of locations that have restricted information related to them, the restricted information relating to said locations and a time period in which the restricted information of the locations is predicted to be accessed, this may be referred to as each location having an “open window”. The remote server apparatus 300 also stores specified ranges for each location relating to restricted information, wherein the specified ranges define the area in which a user is said to be “proximate” the location. Additionally, the remote server apparatus may also store one or more of the following: detection ranges for each location relating to restricted information, wherein the detection ranges define the range in which the location can be detected by the identity card holder and thus define the area in which the identity card holder is “proximate” the location; specified time differences for each location which define the maximum time difference between receiving an access request of the user and the position data of the identity card to ensure the access request is a valid request; a specified time limit for each location wherein the time limit defines the maximum amount of time between receiving first position data and second position data of the identity card holder 100 that allows a comprehensive assumption that the user has been “proximate” the location between the first obtainment of first position data and the second obtainment of second position data and time limits relating to the restricted information, where the time limit defines the time for which the restricted information is accessible.

The remote server apparatus 300 is configured to determine the credential of the user associated with the identity card 200 and provide the user with restricted information related to the location if the credential of the user meets the access requirement of the restricted information and if the position of the identity card holder 100, and hence the user, is proximate the location. In one variation of the system 600 of FIG. 4, the display device 400 of the user is arranged to receive the restricted information related to a location from the remote server apparatus 300 and display the restricted information related to the location and wherein the identity card holder may or may not act as a further verification means explained in the following paragraphs. In another variation, the identity card holder 100 may be configured to receive the restricted information from the remote server apparatus 300 and display it on display 180 and wherein the display device 400 may or may not be used to act as a further verification means explained in the following paragraphs.

The credential of the user to be determined by the remote server apparatus 300 may be one of the following: training level, qualification level and security level of the user. Thus, the access requirement of the restricted information relating to a location proximate the user may be one of the following: a minimum training level, a minimum qualification level and a minimum security level. The restricted information related to a location may be information about a particular task to be carried out. The restricted information may only be suitable to be presented to users that have a minimum training level or a certain security clearance, for example.

In a further variation, before providing the restricted information to the user the remote sever apparatus 300 may send a passcode to either the identity card holder 100 to be displayed on display 180 or the display device 400. The passcode may then be entered on the display device 400 or the display 180 of the identity card holder 100, respectively. This step acts as an additional security check and ensures the user is in possession of both the identity card holder 100 and the display device 400 before the restricted information is provided to the user. This has the advantage of making the system more secure and lessens the risk of the restricted information being provided to a user with a credential that does not meet the access requirement of the restricted information.

Additionally, or alternatively, the identity card holder 100 may have mobile communication ability to allow the identity card holder 100 to receive an incoming call from an authorised contact who is able to verify the identity of the user through human voice check or by the request of a password. Introducing a human voice check means of verifying the user makes the unauthorised extraction of restricted information harder. The authorised person will confirm that the user, who is trying to access restricted information, is who they expect and is thus cleared to view such information.

In a further variation, the identity card holder 100 may have the ability and be configured to alert the user to a need to evacuate an area associated with the location. The alert of the identity card holder 100 may be an audio instruction. In a slight variation, the identity card holder 100 may alert the user by vibrating or by flashing a light. The alert that is provided to the identity card holder 100 may come from the remote server apparatus 300 that holds data on the status of each location at which a user operates. Alerting the user to evacuate the area based on the status of the location stored in the server is a faster, more reliable, and a safer way of alerting the user to potential danger as opposed to the user being alerted by seeing a potential threat, i.e. fire, or by being told by a fellow colleague at the location, which may prove to be a delayed communication that isn't accurate in real-time, or on the other hand, may be incorrect. Often, traditional fire alarm or other safety warning systems are not installed at remote sites. The safety of the user is improved and the user is alerted quickly and reliably about a potentially dangerous threat.

In particular, using an audio alert allows information to be received reliably and quickly by the user. The user may receive a position of the threat, an evacuation route based on the position of the user or advice on how to find other users at a meeting point. These features of an audio alert undoubtedly increase the safety of the user.

The identity card holder 100 is proximate the location of the position if the identity card holder 100 is one of the following: globally verified to be within a specified range of the location, locally verified to be within a specified ranged of the location or locally verified to be at the location. The restricted information related to a location becomes inaccessible to the user when the position of the identity card holder 100 is no longer proximate the location. Global position data may be obtained through GPS, GSM or the like. Local position data may be obtained through Bluetooth®, RFID, and a barcode at the location or the like.

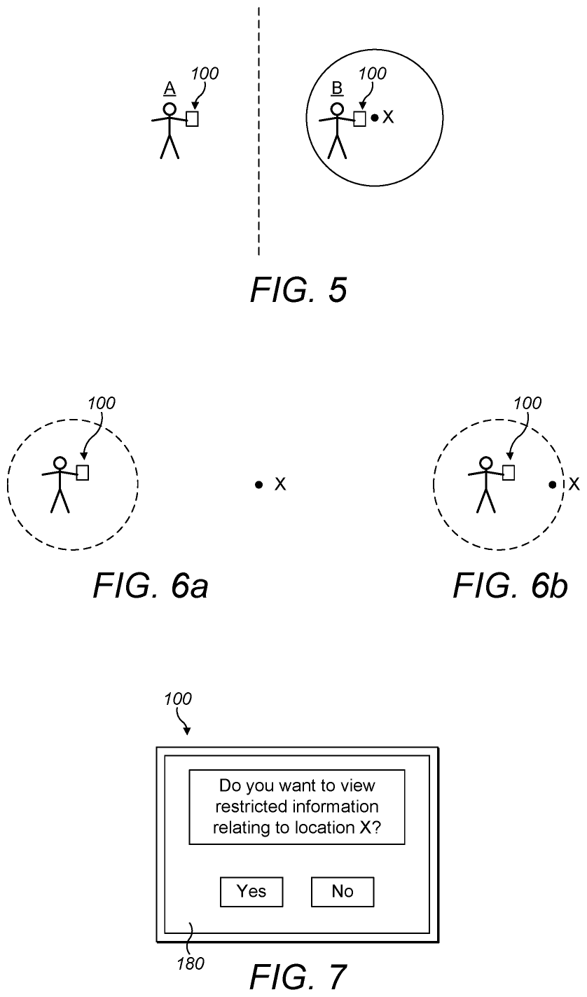

FIG. 5 shows one embodiment of the invention. The identity card holder 100 is shown to be on the user's person. In this embodiment, the positioning circuitry 150 obtains global position data of the identity card holder 100 via GPS, GSM localisation or the like. The location related to the restricted information is labelled location X and has a specified ranged which defines whether the user and hence the identity card holder 100 is proximate the location. If the global location of the identity card holder 100 is within the specified range of location X (shown in FIG. 5 as location B) and assuming the credential of the user meets the access requirement of the restricted information, the restricted information related to location X is accessible to the user. If however, the global location of the identity card holder 100 is not within the specified range of location X (shown in FIG. 5 as location A) the restricted information related to location X is inaccessible to the user. The specified range of location X, or any location relating to restricted information, may have a range of values such as 1 m (for perhaps highly sensitive information) up to 50 m (for perhaps when a location in which the task to be completed covers a large area). Any increment between 1 m and 50 m may also be used as the specified range.

FIG. 6a shows a user with an identity card holder 100 that locally obtains position data. The identity card holder 100 having a range in which it can detect locations with restricted information related to them, wherein the range typically may be 20 m or less. FIG. 6b shows the user has moved closer to a location X and in doing so the location X is now within detection range of the identity card holder 100. Thus, the identity card holder 100 and hence the user, is proximate the location X. Assuming the credential of the user meets the access requirements of the restricted information, the user is then provided with the restricted information relating to location X.

Referring back to FIG. 5, wherein the positioning circuitry 150 of the identity card holder 100 is configured to monitor the global position of the identity card holder 100 repeatedly. The position data of the identity card holder 100 is then sent to the remote server apparatus 300. Assuming the credential of the user meets the access requirements of the restricted information, when the position of the identity card holder 100 is within a specified range of location X i.e. the user is proximate location X, the restricted information related to location X is provided to the user. The restricted information may be automatically provided (pushed) to the display device 400 or the identity card holder 100. An advantage of pushing the restricted information automatically to the user is that the user does not have to interact with the display device 400 or the identity card holder 100 making the process of receiving restricted information easier and less complex for the user. The process is also quicker and may be more efficient. In a variation, dialogue may be presented to the user, on the display device 400 or the identity card holder 100, wherein the dialogue questions the user whether the user wants to receive the restricted information related to location X (push-pull). An advantage of questioning the user whether the user wants to receive restricted information is that the user will not be sent information they do not want to view, for example, they may pass through a specified range of a first location on route to a second location and may not be ready to receive the restricted information relating to the first location, this makes the life of the user easier and less complicated. Another advantage is that the opportunity for making mistakes in audit trail is reduced and inconsistencies between the audit trail and real life events are minimised, for example the restricted information may be logged as “viewed” in the audit trail when it is sent automatically to a user, whereas in reality, the user did not want to view the restricted information associated with the first location and so did not open or did not read the file and thus has not physically “viewed” the restricted information associated with the first location even though it has been logged the contrary. Further to this, the “viewing” of the restricted data may cause a predicted date of completion for the task relating to the restricted information to be calculated, which again would be incorrect as the information has not actually been “viewed” by the user. The identity card holder 100 may then be configured to receive a response from the user. The display device 400 may also be configured to receive a response from the user. Looking to FIG. 7, we can see an example of the dialogue presented to the user on the display 180 of the identity card holder 100.

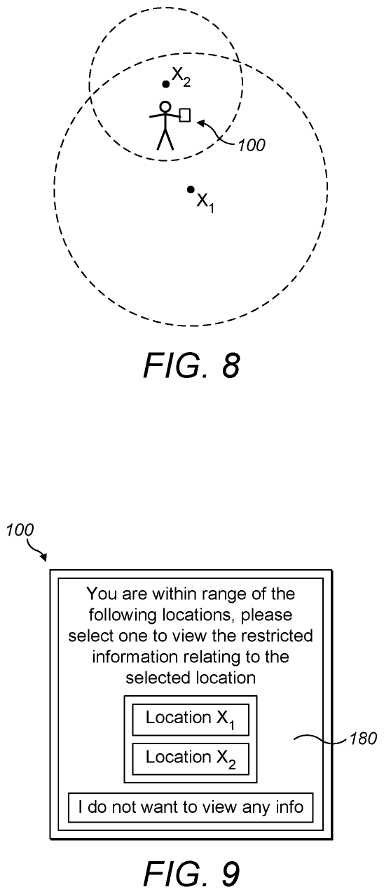

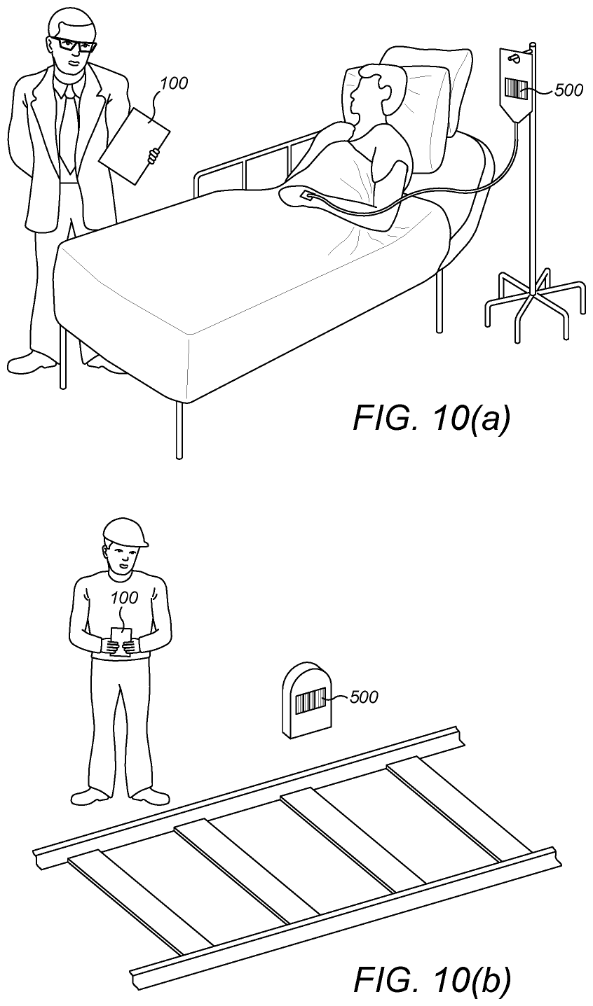

FIG. 8 shows one embodiment of the invention wherein the position of the user may be such that the position coincides with two (or more) specified ranges of two (or more) separate locations (X₁ and X₂) relating to separate restricted information. The user may then be presented with the dialogue, shown in FIG. 9, wherein the user is presented with a choice displayed on display 180 of the identity card holder 100. The user may then select which location (X₁ or X₂), if any, on which they wish to receive related restricted information.

Looking back to FIGS. 6a and 6b, in a similar way as described with reference to FIG. 5, as soon as a location related to restricted information is within the detection range of the identity card holder 100 and hence the identity card holder 100 has detected the location, and assuming the access requirement of the location has been met, the restricted information may be automatically provided (pushed) to the display device 400 or the identity card holder 100. In another embodiment, the user may be presented with the dialogue shown in FIG. 7 which questions the user (push-pull) if the user wants to receive restricted information relating to the location to which they are proximate. The user can then input their choice into the display device 400 or the identity card holder 100. Similarly, if the identity card holder 100 picks up two (or more) locations, such as location X₁ and X₂, the user may then be presented with the dialogue shown in FIG. 9, wherein the user is presented with a choice displayed on display 180 of the identity card holder 100. The user may then select which location (X₁ or X₂), if any, on which they wish to receive related restricted information.

In another embodiment, the restricted information related to the location may only be provided to the user after the user has issued an access request (pull) to the remote server apparatus 300 and that access request has been classified as a valid request. An advantage of the requirement of an access request gives the user more control about what restricted information they wish to receive. A further advantage is that the positioning circuitry 150 does not need to monitor the position of the identity card holder 100 repeatedly. The positioning circuitry 150 only needs to obtain position data once an access request has been issued by the user, and this will help to save power on the identity card holder 100. The remote server apparatus 300 may then check that the position of the identity card holder 100 is within the specified range of (and hence proximate) the location relating to the access request. The access request issued by the user may be classified to be a valid request by the remote server apparatus 300 if the position data of the identity card holder 100 and the access request are received by the remote server apparatus 300 either at the same time, or within a specified time of one another (for example, from one second to ten minutes). Performing a check to ensure the access request is a valid request ensures the user in possession of the identity card holder 100 is proximate the location when the access request is issued.

As previously discussed, the position of the identity card holder 100 may be proximate the location if the identity card holder 100 can be locally verified to be at the location. The local verification may involve obtaining local position data of the identity card holder 100 by entry of a location ID wherein the location ID is at the location. The location ID may be entered into the identity card holder 100 by the interface 130 wherein the interface 130 may scan the location ID or receive a manually inputted location ID or the display 180 of the identity card holder may receive a manually inputted location ID. In another embodiment, it may be the display device 400 that is configured to scan the location ID or receive a manually inputted location ID. Once the location ID has been entered and the position data has been obtained, the type of task to be completed and type of equipment to be used at the location can be logged in an audit trail. This creates a comprehensive and accurate account of the proceedings at the location relating to the location ID. In addition to this, the equipment to be used may be verified by the scanning of an equipment ID located on the equipment to be used at the location. The equipment to be used at the location may then be logged in the audit trail. The use of equipment ID is particularly useful at a location where more than one piece of equipment is to be used. The scanning of the equipment IDs in the order in which they are to be used also allows for a thorough audit trail to be created with a realistic representation of the proceedings that occurred at the location.

FIGS. 10a and 10b both show different examples of when an equipment ID and a location ID may be used respectively. FIG. 10a showing an equipment ID in the form of a barcode positioned beside a bed of a patient on the medical equipment of the patient. In alternative embodiments, the equipment ID may be positioned on one or more of the following: medical instrumentation devices, diagnostic devices, prescribed drugs and medical treatment devices, for example an inhaler, IV drip, heart monitor or blood pressure monitor. In a further embodiment, the equipment ID may be positioned on one or more of the following: calibration equipment, repair equipment and construction equipment, for example a voltmeter, drill, pipe, section of railway track or a forklift. FIG. 10b shows a location ID in the form of a barcode positioned on a marker located at a position besides a section of railway track. In alternative embodiments, the location ID may be positioned on a bed of a patient, on an underground pipe and on a post in a construction site. To ensure the user remains proximate the location the user may be required to re-enter the location ID within a specified time limit, so that the remote sever receives first position data then second position data of the identity card holder. The specified time limits may be from 1 minute (for perhaps highly sensitive restricted information) to 30 minutes (for perhaps tasks that may take hours to complete wherein re-entering the location data at a frequency higher than this would be detrimental to the completion of the task). The specified time limits may be any variant between 1 minute and 30 minutes.

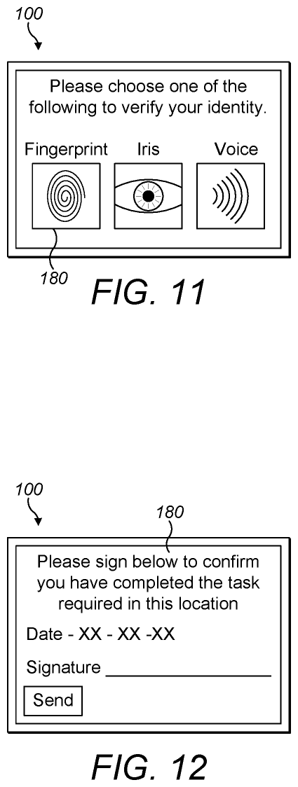

In another embodiment of the invention, shown in FIG. 11, the user may be presented with dialogue on the display 180 of the identity card holder 100 or the display device 400 that asks the user to input identification data for example biometric data, such as finger print, iris or voice data, ID number or passcode. The dialogue asking the user to input identification data may be presented to the user before the restricted information is provided to the user. In another embodiment, the user may get a call to his mobile phone registered in the remote server apparatus 300, wherein verification is complete if the user picks up the call and speaks and the user's voice matches the voice data stored on the remote server apparatus 300, verification may also be complete if the user answers a series of security questions. An advantage of both of the above second stages of verification is that the security of the system is improved and the opportunity for the wrong person to gain access to restricted information relating to a location is minimised. Wherein, for example, the wrong person may be a person whose credential does not meet the access requirement of the restricted information.

In a further embodiment, shown in FIG. 12, once the user has finished using the restricted information related to the location, they may be presented with a dialogue that asks them to electronically sign a dated declaration. This declaration can be sent directly to the remote server apparatus 300. An advantage of signing a declaration in real time and sending the signed declaration to the remote server apparatus 300 almost straight away is that an audit trail can be formed easily and quickly with no intermediate administrative stages slowing the process down to make it inefficient.

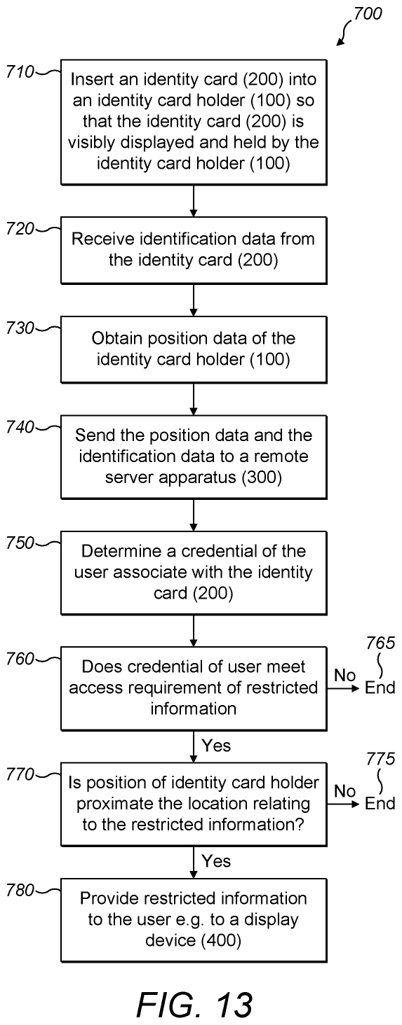

FIG. 13 shows a schematic flow chart representative of the method 700 of the invention for accessing restricted information. Firstly, at step 710 the identity card 200 is inserted into the identity card holder 100. Optionally, the identity card 200 is visibly displayed and held by the identity card holder 100. At step 720 identification data is then received from the identity card 200 and at step 730 position data of the identity card holder 100 is obtained. At step 740 the position data and the identification data are then sent to the remote server apparatus 300. At step 750 the credential of the user is then determined. At step 760 it is determined whether the credential of the user meets the access requirement of restricted information relating to a location. If so, it is then determined, at step 770, whether the position of the identity card holder 100 is proximate the location relating to the restricted information. If so, at step 780, the restricted information is provided to the user, perhaps to the display device 400 of the user. It can be appreciated that steps 760 and 770 do not have to be executed in the above order and the above order may be reversed. Steps 765 and 775 illustrate the end of the process where the credential of the user did not meet the access requirement of the restricted information and the position of the identity card holder is not proximate the location, respectively. At both steps 765 and 775 the user may be presented with a dialogue informing the user that access has not be granted to the restricted information. Any unsuccessful attempts to access restricted information may be logged in the audit trail.

Of course, the skilled reader would appreciate that the identity card holder 100 could be configured to perform the function of the remote server 300.

In another embodiment of the invention, not depicted in a figure, once the schedule of tasks to be performed at certain locations is stored on the server 300, the server 300 may encrypt the restricted information associated with each location and send the encrypted information associated with each location to the display device 400. Once the position of the identity card holder 100 is proximate the location where a task is scheduled to be completed the server 300 may send an encryption key for the restricted information relating the location to the identity card holder 100 to be inputted by the user into the display device 400. The restricted information may then be accessed by the user. If the user is no longer proximate the location the restricted information may become inaccessible and may only be accessed once the encryption key is re-entered in a position that is proximate the location. The encrypted information stored on the server may be downloaded onto the display device at a certain time before the task is ready to be completed, this may be for example, 30 minutes before the task is scheduled to be completed. In a slight variation, encrypted restricted information relating to tasks scheduled to be completed within a certain time period may be downloaded in bulk where the time period may be the duration of the worker's shift for example, 8 am to 6 pm. Similar to the embodiment of the invention depicted in FIGS. 5, 6a, 6b and 8 the encryption key may be “pushed” automatically to the user. Similar to the invention of FIG. 7, the user may first be presented with dialogue asking the user if they wish to receive the encryption key for the restricted information relating to for example, location X. If close to more than one location on the user's schedule the user may be presented with a choice such as in FIG. 9, on the other hand the tasks to be completed may have to be completed in time order so a choice would not be provided to the user.

The restricted information relating to a location is about a particular task to be carried out at the location. The restricted information provided to the user may include an inspection sheet that is a real time verified documentation that may be specific to a piece of equipment at the location or overall task to be completed at the location. The inspection sheet includes a checklist of sub-tasks to be completed at the location, where the sub-tasks may require the use of pieces equipment at the location and where the sub-tasks may be performed on one piece of equipment. The inspection sheet is filled out in real time as the user completes sub-tasks or uses equipment at the location. In one embodiment, assuming the credential of the user meets the access requirement of the restricted information, the entry of a location ID may trigger the opening of the inspection sheet which presents the user with a checklist of sub-tasks associated with the location that must be completed before a signed and dated declaration stating that the task at the location has been completed can be sent to the remote server apparatus. In a further embodiment, also assuming the credential of the user meets the access requirement of the restricted information, when an equipment ID is entered into the identity card holder 100 this may trigger the opening of the inspection sheet which may present to the user with a checklist to be completed using the equipment associated with the equipment ID before the user can electronically sign a dated declaration stating that the task associated with the location has been completed.

The particular task to be completed at a location may be one or more of the following, a health worker (e.g. a doctor) performing a health assessment on a patient, a health worker diagnosing a patient, a health worker prescribing medication to a patient, a health worker using medical equipment on the patient, a maintenance worker (e.g. a technician) calibrating equipment, a maintenance worker repairing maintenance equipment, a maintenance worker checking equipment, a maintenance worker using equipment to repair damage at the location or build a new structure at the location.

The invention may be carried out in a number of different embodiments two of which are depicted below.

### Example 1

Worker Q has an identity card holder 100 with his identity smart card 200 held by the identity card holder 100. Worker Q has been sent to complete a maintenance job at location X. Restricted information is required to complete the job. The remote server apparatus 300 has stored the global position of location X along with the specified range of location X. The specified range in this instance, is twenty metres. The communications circuitry 150 of the identity card holder 100 of worker Q monitors the position of worker Q repeatedly and sends the position data to remote server apparatus 300. The interface 130 of the identity card holder 100 retrieves the identification data from the identity smart card 200 of worker Q and stores it temporarily in memory 120. The identification data may then be sent at the same time as the position data to the remote server apparatus 300. The remote server apparatus 300 determines whether worker Q is proximate location X and if so, determines the credential of worker Q and if the credential meets the access requirement of the restricted information related to the location to which worker Q is proximate, worker Q may be presented with a dialogue on his secondary display device 400. The dialogue may be similar to that shown in FIG. 7 wherein worker Q is asked whether he wishes to receive restricted information relating to the location to which he is proximate. If worker Q accepts the restricted information it will then be downloaded to his display device 400 in order for him to complete the maintenance task. As the position of worker Q, and hence the identity card holder 100, is being repeatedly monitored, if for some reason, worker Q strays further than the specified range of 20 m from location X worker Q will no longer be proximate location X, and the restricted information relating to location X will no longer be accessible to worker Q. If worker Q then becomes proximate location X worker Q will then be able to access the restricted information again, although a time limit may be set in which worker Q has to return to being proximate location X. Further to this, worker Q may be presented with dialogue such as in FIG. 11, asking for worker Q to input identification data to verify his identity.

The restricted information provided to worker Q includes an inspection sheet. Once worker Q is proximate the location worker Q is presented with the inspection sheet that includes a check-list of sub-tasks that must be completed at location X. When worker Q completes a sub-task he can mark the sub-task as completed using the display device. The time of completion of the sub-task is logged automatically on the inspection sheet which will later become part of the audit trail. Once all the sub-tasks have been completed at location X worker Q may be presented with dialogue shown in FIG. 11 so that he can verify his identity. After this dialogue, he may then be presented with the dialogue of FIG. 12 where he can sign electronically a dated declaration. The declaration may then be sent electronically to the remote server apparatus 300 with the inspection sheet so that the times of completion of the sub-tasks and the signed declaration of worker Q can form part of the audit trail for the company in which worker Q is employed.

### Example 2

Worker P has been sent to visit a patient at their home, location X. Worker P requires restricted information to complete a health task on the patient at location X. Worker P is wearing his identity card holder 100 with his identity card 200 inserted into and held by the identity card holder 100. To verify his position, worker P can scan an RFID tag positioned on the patient's medical equipment using the identity card holder 100. The positioning circuitry can then send the position data to a remote server apparatus 300. The interface 130 of the identity card holder 100 reads identification data from the identity card 200 and stores it temporarily in memory 120 and then sends it to the remote server apparatus 300. Worker P can then issue an access request by navigating through a menu on his display device, wherein the access request is sent to the remote server apparatus 300. The remote server 300 checks location X is due to be worked on and checks that the credential of the user meets the access requirement of the restricted information related to location X. The remote server 300 then checks if the access request has been sent within a specified time difference of the position data, in this case the time difference can be up to 5 minutes, the access request is then classified as a valid request. The restricted information is then provided to the display device of worker P. Worker P has a time limit in which to re-scan the RFID tag on the medical equipment of the patient and re-send the position data to the remote server apparatus 300, the time limit in this instance is 15 minutes. If worker P fails to rescan the RFID tag within this time limit the restricted information relating to location X is no longer accessible to the user. To re-gain access worker P will have to re-scan the RFID tag, re-issue an access request and may have to enter identification data such as biometric data into the identity card holder 100 to further verify his identity. If worker P uses any equipment or any drugs, barcodes on the equipment and/or drugs can be scanned and this data can be sent to the remote server straight away to form part of the audit trail.

1-10. (canceled)

11. An identity card holder comprising:
a processor;
a memory;
an interface for communicating with an identity card;
long-range communications circuitry for communicating with a remote server apparatus remote from the identity card holder;
wherein the processor is configured:
to receive identification data from the identity card via the interface to identify a user;
to use the long-range communications circuitry to communicate identity data, the identity data being or being at least based on the identification data, to the server apparatus remote from the identity card holder.

12. The identity card holder of claim 11, wherein the processor is further configured to receive restricted information from the remote server apparatus.

13. The identity card holder of claim 12, wherein the restricted information is relevant to the user.

14. The identity card holder of claim 12, wherein the processor is further configured to receive restricted information from the remote server apparatus in response to communicating identity data to the remote server apparatus.

15. The identity card holder of claim 12, wherein when the user has a required clearance to access the restricted information, the required clearance is verified using the identity data.

16. The identity card holder of claim 12, wherein the restricted information comprises instructions for a user of the identity card holder to carry out a task.

17. The identity card holder of claim 16, wherein the instructions to carry out the task are available to the user of the identity card holder for a limited time period.

18. The identity card holder of claim 11, further comprising a geolocation module that can determine a location of the identity card holder.

19. A server apparatus, wherein the server apparatus comprises:
a processor;
a memory; and
long-range communications circuitry capable of establishing communications with an identity card holder, wherein the identity card holder is remote from the server apparatus;
wherein the server apparatus processor is configured to:
receive identity data from the remote identity card holder, the identity data indicating the identity of a user using the identity card holder.

20. The server apparatus of claim 19, wherein the server apparatus processor is further configured to send restricted information to the remote identity card holder.

21. The server apparatus of claim 20, wherein the restricted information is relevant to a user of the remote identity card holder.

22. The server apparatus of claim 20, wherein the server apparatus is further configured, prior to sending the restricted information to the identity card holder, to check whether the user has a required level of clearance to receive the restricted information.

23. A method of operating an identity card system, the method comprising:
at an identity card holder, detecting the presence of an identity card and reading information therefrom which allows an identity of a user associated with the identity card to be known, and sending the information to a remote server;
at a remote server:
logging information received from the identity card holder regarding the identity of the user associated with the identity card and information regarding the identity card holder; and
sending restricted information to the identity card holder, wherein the restricted information is relevant to a user of the identity card holder.
